(19) United States
(12) Patent Application Publication
(10) Pub. No.: US 2016/0162365 A1
(43) Pub. Date: Jun. 9, 2016

(54) STORING DIFFERENCE INFORMATION IN A BACKUP SYSTEM

(71) Applicant: LONGSAND LIMITED, Cambridge (GB)

(72) Inventor: William Russell Clark, Southborough, MA (US)

(21) Appl. No.: 14/906,649

(22) PCT Filed: Jul. 31, 2013
(86) PCT No.: PCT/US2013/053037

§ 371 Date: Jan. 21, 2016

(51) Int. Cl. G06F 11/14

(52) U.S. Cl. CPC G06F 11/1451; G06F 11/1458; G06F 2201/84

(57) ABSTRACT

Examples disclosed herein relate to storing difference information in a backup system. Examples include storing, in remote backup storage of the backup system, difference information representing differences between data stored locally at a computing device and a version of the data stored in the version control storage of a version control system.

### BACKGROUND

A computing device may generate a large amount of data, which may be stored locally by the computing device. Loss of such data resulting from a failure of the computing device, for example, may be detrimental to an enterprise, individual, or other entity utilizing the computing device. To protect the data from loss, a backup system may store at least a portion of the computing device's data. In such examples, if a failure of the computing device prevents retrieval of some portion of the data, it may be possible to restore the data from the backup system.

### BRIEF DESCRIPTION OF THE DRAWINGS

The following detailed description references the drawings, wherein:

FIG. 1 is a block diagram of an example computing device to store difference information in a backup system;

FIG. 2 is a block diagram of an example computing device to restore data from data stored in a version control system and from difference information stored in a backup system;

FIG. 3 is a flowchart of an example method for storing difference information in a backup system; and

FIG. 4 is a flowchart of an example method for determining whether data associated with location information is selected for version aware backup by a backup system.

### DETAILED DESCRIPTION

As used herein, a “backup system” (or “data backup system”) may be a data storage system to copy data stored by a computing device to storage, of the data storage system, that is separate from the computing device, and to restore the copied data to the computing device or other storage. As an example, a backup system may copy data of a computing device to storage of the backup system, and if the data stored on a computing device is subsequently lost, the backup system may restore the copied data to the computing device or other storage. A backup system may be able to back up large amounts of data. However, reducing the amount of data backed up by users of the backup system may increase the performance of the backup system and lower the cost of providing the backup system to users. As such, it may be desirable to implement features that reduce the amount of data that users back up.

In some examples, some of the data stored locally at a computing device may be under the control of a version control system. Such data (e.g., file(s), director(ies), etc.) under the control of a version control system may be referred to herein as “version controlled” data. As used herein, a “version control system” (which may be referred to as “revision control” or “source control” system) may be a system to store multiple versions (or “revisions”) of data (e.g., file(s), director(ies), etc.) each comprising a copy of the data as it existed at a respective time. As used herein, a “version” of data is a copy of the data as it existed at a given time. In some examples, each version or the data stored by the version control system may be associated with respective version information that identifies the version of the data (e.g., a respective version number or other version identifier). In some examples, such a given version of data stored by a version control system may be retrieved at any time from the version control system. As such, backing up version controlled data in a backup system may be inefficient, as a version of the data may already be stored in the version control system. Since this version may generally be retrieved from the version control system at any time, it may be redundant to fully back up the version controlled data, as portions of the version controlled data may end up being stored in both the version control system and the backup system.

To address these issues, in examples described herein, a backup system may acquire, from a version control system, version access information associated with data stored locally by the computing device, where the version access information is useable to access a version of the data that is stored in the version control system. In such examples, the backup system may store, in remote backup storage of the backup system, the version access information and difference information representing differences between the data stored locally and the version of the data stored in the version control storage. The backup system may further restore the data to the computing device from at least the version of the data stored in the version control storage and the difference information stored in the remote backup storage.

In such examples, the backup system may omit fully backing up version controlled data and instead limit the backup of such data to differences between the data and a full version of the data stored in the version control system, and data useable to obtain the full version of the data from the version control system. In this manner, the backup system may achieve a significant reduction in the amount of storage occupied to back up the data of a computing device when that data includes version controlled data. Additionally, the reductions achieved by such examples may be substantial, as version control is commonly used to manage data such as source code for software development projects.

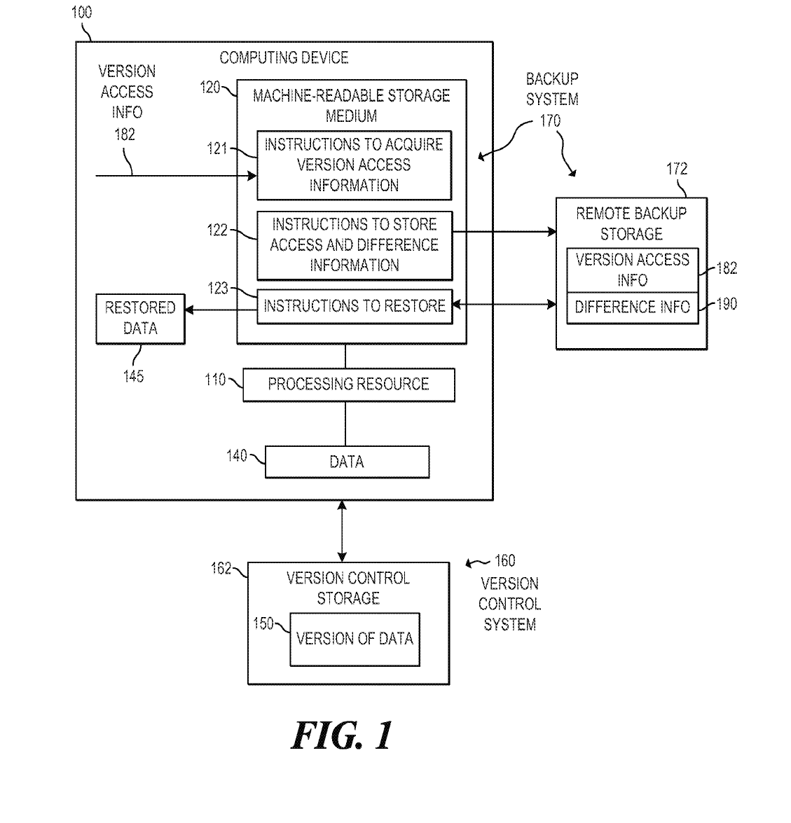

Referring now to the drawings, FIG. 1 is a block diagram of an example computing device 100 to store difference information in a backup system 170. As used herein, a “computing device” may be a desktop computer, notebook computer, workstation, tablet computer, mobile phone, smart device, server, blade enclosure, or any other processing device or equipment. In the example of FIG. 1, computing device 100 includes a processing resource 110 and a machine-readable storage medium 120 encoded with instructions 121-123. In some examples, storage medium 120 may include additional instructions. In some examples, instructions 121-123, and any other instructions described herein in relation to storage medium 120, may be stored on a machine-readable storage medium remote from but accessible to computing device 100 and processing resource 110.

In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processing resource 110 may fetch, decode, and execute instructions stored on storage medium 120 to perform the functionalities described below. In other examples, the functionalities of any of the instructions of storage medium 120 may be implemented in the form of electronic circuitry, in the form of executable instructions encoded on a machine-readable storage medium, or a combination thereof.

In the example of FIG. 1, computing device 100 may be in communication with version control storage 162 of a version control system 160. Computing device 100 may also be in communication with backup storage 172 of backup system 170. Version control storage 162 and backup storage 172 may each be implemented by at least one machine-readable storage medium. As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

In some examples, computing device 100 may be in communication with each of version control storage 162 and backup storage 172 via a computer network. As used herein, a computer network may include, for example, a local area network (LAN), a wireless local area network (WLAN), a virtual private network (VPN), the Internet, or the like, or a combination thereof. In some examples, a computer network may include a telephone network (e.g., a cellular telephone network), in some examples, backup storage 172 may be remote from computing device 100 and may be referred to herein as “remote” backup storage 172. As used herein, storage (or any other computing resource) “remote” from a computing device is storage (or another computing resource) that is exclusively accessible by the computing device via a computer network. For example, storage that is “remote” from computing device 100 may be accessible via at least one component of a computer network (e.g., a router or other computer networking device, etc.), at least one computer network interface (e.g., a network interface card (NIC)) of computing device 100, or the like, or a combination thereof.

In some examples, instructions 121-123 of storage medium 120 may implement at least a portion of backup system 170. For example, instructions 121-123 may implement at least a portion of a backup agent of backup system 170. In such examples, the backup agent may be installed on computing device 100. In the example of FIG. 1, instructions 121 may detect that backup operation of backup system 170 has been triggered for computing device 100. As used herein, a “backup operation” of a backup system is a process of the backup system to copy (in whole or in part) data stored in storage separate from the backup storage to storage of the backup system. In some examples, a backup operation may include detecting the data to be copied to the backup storage. In some examples, a backup operation may be triggered manually by a user of at least one of computing device 100 and backup system 170, or may be triggered by backup system 170 based at least in part on a predefined schedule of backup system 270.

In response to a backup operation of backup system 170 being triggered for computing device 100, instructions 121 may detect data 140 stored locally at computing device 100. As used herein, data stored “locally” at a computing device is data stored in at least one machine-readable storage medium of the computing device, such as a storage drive (e.g., a hard drive) of the computing device, or any other suitable storage of the computing device. In some examples, data stored locally at a computing device may be data accessible by the computing device independent of any computer network. For example, the locally stored data may be accessible to the computing device via at least one internal bus or other internal communication mechanism(s) of the computing device. In the example of FIG. 1, locally stored data 140 may be stored on a hard drive or other machine-readable storage medium of computing device 100.

In response to detecting data 140 stored locally by computing device 100, instructions 121 may acquire version access information 182 associated with data 140. Version access information 182 may be information useable by computing device 100 to access a version 150 of data 140, where the version 150 is stored remotely from computing device 100 in version control storage 162 of version control system 160.

In some examples, version access information 182 may include version information and location information. The version information may identify version 150 of data 140 stored in version control storage 162 of version control system 160. For example, version control system 160 may store multiple versions of data 140 (including version 150), each version representing data 140 as it existed at a respective time. In such examples, data 140 stored locally at computing device 100 may be associated with version 150 of the data and the version information identifying version 150.

As noted above, data 140 may be associated with version information identifying version 150 representing data 140 as it existed at a given time. As an example, data 140 may have been created by copying (e.g., checking out) version 150 from version control system 160 to computing device 100. In some examples, changes may have been made to data 140 after it was copied from version 150 such that data 140 differs from version 150. Alternatively, version 150 may have been created by copying (e.g., checking in) data 140 to version control system 160 at a given time. In some examples, changes may have been made to data 140 after creating version 150, such that data 140 differs from version 150. In each of these examples, version 150 represents data 140 as if existed at a given time, and data 140 may be associated with version information identifying version 150. This association may be made by version control system 160 (e.g., an agent of system 160 installed on computing device 100).

In the example of FIG. 1, the location information of version access information 182 may identify a remote computer network location of version control storage 162 at which version 150 of data 140 is accessible to computing device 100. For example, the location information may comprise a uniform resource locator (URL) identifying a location at which version 150 in version control storage 162 is accessible via a server at least partially implementing version control system 160. In some examples, version access information 182 for data 140 may be maintained on computing device 100 by, for example, an agent (e.g., executable instructions) of version control system 160 installed on computing device 100. In such examples, instructions 121 may acquire version access information 182 from a version control system 160 (e.g., from the version control agent).

As noted above, in examples described herein, a backup system may omit fully backing up version controlled data and instead limit backup to differences between the data and a full version stored in the version control system, and data useable to obtain the full version from the version control system, which may be referred to herein as a “version aware backup” of the data. In some examples, a user of the backup system may be given the option of selecting certain version controlled data for such version aware backup. In some examples, a user of the backup system may select certain version controlled data to which version aware backup is to be applied by specifying location information to be relied upon for the version aware backup. For example, the specified location information may indicate location(s) from which version(s) of the selected version controlled data may be retrieved from the version control system.

In such examples, the specified (i.e., selected) location information may be stored (or otherwise represented) in version aware backup information maintained by backup system 170. In such examples, backup system 170 may perform version aware backup on data if location information associated with the data (e.g., identifying a location at which a version of the data is accessible in version control storage) is represented among the version aware backup information. In some examples, a given location may be represented among the version aware backup information includes information identifying the given location itself or includes information identifying a higher-level location (e.g., parent directory or path) containing the given location.

As an example, in response to acquiring version access information 182, instructions 122 may compare the location information (e.g., a URL) of version access information 182 associated with data 140 to a plurality of locations (e.g., URLs) specified in version aware backup information, instructions 122 may determine, based on the result of the comparison, that a backup of data 140 by backup system 170 is to be limited based on content stored by version control system 160 (e.g., using version aware backup, as described above). For example, instructions 122 may determine that backup system 170 is to apply version aware backup to data 140 if the result of the comparison indicates that the location information of version access information 182 is represented in the version aware backup information.

In response to the determination that backup system 170 is to apply version aware backup to data 140, instructions 122 may acquire difference information 190 for data 140 stored locally at computing device 100. In examples described herein, “difference information” for data stored locally at a computing device is information representing differences between the data stored locally and a version of the data stored in the version control storage. In some examples, the difference information may represent each difference between the data stored locally and a version of the data stored in the version control storage. In the example of FIG. 1, difference information 190 represents differences between data 140 stored locally at computing device 100 and version 150 of the data identified by version access information 182 and stored in version control storage 162 of version control system 160. In some examples, instructions 122 may acquire difference information 190 from version control system 160 (e.g., from a version control agent of system 160 installed on computing device 100). In other examples, instructions 122 may generate difference information 190. Instructions 122 may further store version access information 182 and difference information 190 in remote backup storage 172 of backup system 170. In some examples, instructions 122 may store version access information 182 and difference information 190 in remote backup storage 172 such that, during a restore operation, backup system 170 is to restore the data (e.g., to the computing device or any other storage medium) from at least version 150 of data 140 stored in version control storage 162 and difference information 190 stored in remote backup storage 172. As used herein, a “restore operation” may be a function of a backup system to restore data at least partially stored in the backup system to a storage medium separate from storage of the backup system.

Alternatively, instructions 122 may determine that backup system 170 is to apply non-version aware backup to data 140 if the result of the comparison indicates that the location information of version access information 182 is not represented in the version aware backup information. In examples described herein, “non-version aware backup” may include any backup process(es) by which a backup system may back up data in the backup system such that the data may be restored from the backup system independent of any version control system. In other examples, instructions 122 may determine to skip the backup of data 140 if the result of the comparison indicates that the location information of version access information 182 is not represented in the version aware backup information.

In examples in which backup system 170 performs version aware backup on data 140, instructions 123 may restore data 140 to computing device 100 from at least the version 150 of data 140 stored in version control storage 162 and difference information 190 stored in remote backup storage 172. In the example of FIG. 1, restored data 145 represents data 140 as restored by instructions 123. Restored data 145 may be restored to a storage medium of computing device 100. As used herein, to “restore” data is to provide data, as it existed at the time of a backup operation performed for the data, to a target system or storage medium. For example, instructions 123 may access version access information 182 stored in remote backup storage 172 and may use version access information 182 (i.e., the version and location information) to acquire version 150 from version control storage 162. In such examples, instructions 123 may further retrieve difference information 190 from remote backup storage 172 and incorporate each difference represented in difference information 190 into version 150 to produce restored data 145 (e.g., by merging version 150 and difference information 190).

As noted above, instructions 121-123 may implement at least a portion of a backup agent of backup system 170. In some examples, backup system 170 may include other backup agents at other computing devices. In such examples, another backup agent at a computing device other than computing device 100 may restore data 140 to a target storage medium of the other computing device using the process described above in relation to instructions 123. Similarly, instructions 123 may use the process described above restore, to computing device 100, data that was not backed up by the backup agent installed on computing device 100.

In some examples, the data 140 stored locally at computing device 100 may comprise a plurality of version controlled files in a directory. In such examples, version 150 of data 140 stored in version control storage 162 may comprise a respective version of each of the version controlled files. In some examples, difference information 190 may comprise a change file specifying, for each of the version controlled files of data 140, differences (e.g., each difference) between the version controlled file stored locally (i.e., in data 140) and the version of the version controlled file stored in version control storage 162.

In some examples, the change file may be a patch file or any other suitable type of file representing each of the differences (i.e., all of the differences). In some examples, the change file may indicate, for each of the version controlled files, each line changed and the change made in each line relative to the respective version of the version controlled file contained in version 150. In such examples, the change file may exclude each line of each file of data 140 that remains unchanged relative to version 150. In some examples, instructions 122 may acquire the change file by calling an appropriate function of version control system 160 (e.g., by calling a function of the version control agent installed on computing device 100), which may return the change file. In other examples, difference information 190 may include a copy of each file of data 140 that is changed relative to the version of the file included in version 150, while excluding each file of data 140 that is unchanged relative to version 150.

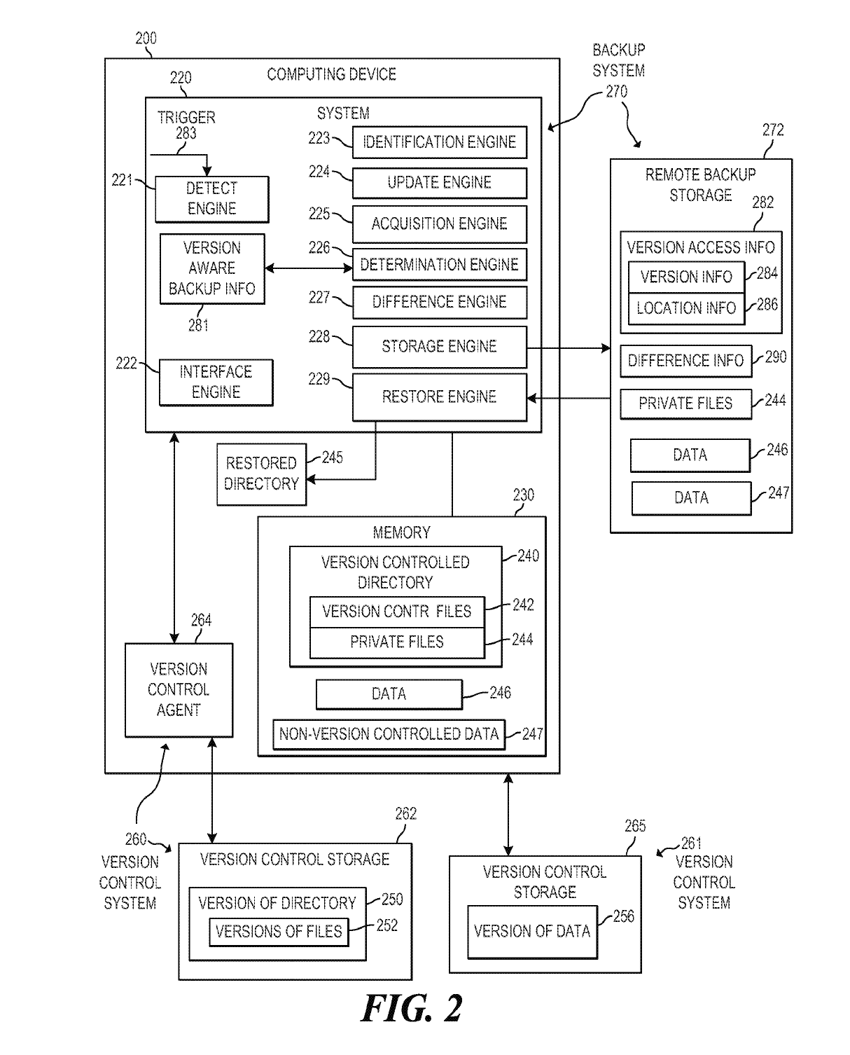

In some examples, instructions 121-123 may be part of an installation package that, when installed, may be executed by processing resource 110 to implement the functionalities described herein in relation to instructions 121-123. In such examples, storage medium 120 may be a portable medium, such as a CD, DVD, or flash drive, or a memory maintained by a server from which the installation package can be downloaded and installed. In other examples, instructions 121-123 may be part of an application, applications, or component already installed on computing device 100 including processing resource 110. In such examples, the storage medium 120 may include memory such as a hard drive, solid state drive, or the like. In some examples, functionalities described herein in relation to FIG. 1 may be provided in combination with functionalities described herein in relation to any of FIGS. 2-4.

FIG. 2 is a block diagram of an example computing device 200 to restore data from data stored in a version control system and from difference information stored in a backup system. In the example of FIG. 2, computing device 200 includes a system 220 comprising engines 221-229. In some examples, system 220 may include additional engines. System 220 may implement at least a portion of a backup system 270. For example, system 220 may implement at least a portion of a backup agent of backup system 270.

Each of the engines of system 220 may be any combination of hardware and programming to implement the functionalities of the respective engine. Such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement system 220. The machine-readable storage medium storing the instructions may be integrated in a computing device including the processing resource to execute the instructions, or the machine-readable storage medium may be separate but accessible to the computing device and the processing resource. The processing resource may comprise one processor or multiple processors included in a single computing device or distributed across multiple computing devices. In other examples, the functionalities of any of the engines may be implemented in the form of electronic circuitry.

In some examples, the instructions can be part of an installation package that, when installed, can be executed by the processing resource to implement system 220. In such examples, the machine-readable storage medium may be a portable medium, such as a CD, DVD, or flash drive, or a memory maintained by a server from which the installation package can be downloaded and installed. In other examples, the instructions may be part of an application, applications, or component already installed on a computing device including the processing resource. In such examples, the machine-readable storage medium may include memory such as a hard drive, solid state drive, or the like.

In the example of FIG. 2, system 220 is in communication with version control storage 262 of a version control system 260, version control storage 265 of a version control system 261, and remote backup storage 272 of backup system 270. System 220 may be in communication with each of version control storage 282, version control storage 265, and backup storage 272 via at least one computer network. Each of storage 262, 265, and 272 may be remote from computing device 200 and may each be implemented by at least one machine-readable storage medium.

Computing device 200 may comprise memory 230, which may be implemented by at least one machine-readable storage medium. In the example of FIG. 2, memory 230 may store data 240, which may be a version controlled directory 240 comprising a plurality of version controlled files 242. Although computing device 200 is described in relation to an example in which data 240 is a version controlled directory, in other examples, data 240 may be any other suitable type of data. In the example of FIG. 2, a version 250 of directory 240 is stored remotely from computing device 200 in version control storage 262 of version control system 260. In the example of FIG. 2, version control system 260 may be separate from backup system 270. In such examples, version control storage 262 may be separate from remote backup storage 272.

In the example of FIG. 2, detect engine 221 may detect a trigger 283 to begin a backup operation of backup system 270 for computing device 200. Trigger 283 may result from a user-input command to begin a backup operation, or may be provided by system 220 based on a pre-defined backup schedule. In response to the backup operation of backup system 270 being triggered, identification engine 223 may identify at least one version control system utilized by computing device 220. For example, engine 223 may identify version control system 280 utilized by computing device 200. Engine 223 may also identify version control system 261 that is utilized by computing device 200. In some examples, for each version control system of a predefined list of such systems, engine 223 may search computing device 200 for evidence that computing device 200 utilizes the version control system. Upon finding such evidence for a given version control system, engine 223 may determine that the given version control system is utilized by computing device 200. As an example, engine 223 may search for such evidence among registry keys, file(s) at a given install path, commands registered with an operating system (OS) of computing device 200, or the like.

Also in response to the backup operation being triggered, engine 221 may defect version controlled directory 240 stored locally at computing device (i.e., in memory 230). In response to the backup operation being triggered, and in response to the detection of directory 240, update engine 224 may determine whether version controlled directory 240 and version controlled files 242 are associated with the same version identifier (e.g., version number) of version control system 260. In response to a determination that any of version controlled files 242 and version controlled directory 240 are associated with different version identifiers of version control system 260 (and thus different versions stored by version control system 260), update engine 224 may cause version control system 260 to update at least one of the version controlled files 242 and version controlled directory 240 such that, after the update, they are each associated with the same version identifier of version control system 260. In such examples, version controlled files 242 and directory 240 may be updated to be consistent with the same revision before proceeding further with the triggered backup operation. In response to a determination that the version controlled files 242 and directory 240 are associated with the same version identifier, the triggered backup operation may proceed without engine 224 performing the update operation.

In the example of FIG. 2, in response to the backup operation being triggered and the detection of directory 240, acquisition engine 225 may acquire version information 284 and location information 286 associated with directory 240. Version information 284 may identify a version 250 of directory 240 stored in version control storage 262 that represents directory 240 as it existed at a given time, and location information 286 may specify a location (e.g., a computer network location) at which version 250 is accessible by computing device 200 in version control storage 262. Version and location information 284 and 286 may be associated with directory 240 stored locally at computing device 200 by version control system because version 250 represents directory 240 as it existed at a given time.

Version information 284 may be a version or revision number (or other identifier) that identifies version 250 stored in version control system 260. Location information 286 may be a URL (or other suitable information) identifying a location at which version 250 in version control storage 262 is accessible via a server at least partially implementing version control system 260. In some examples, engine 225 may acquire the version and location information 284 and 286 from a version control agent 264 of version control system 260. In some examples, version control agent 264 may be software (e.g., machine-executable instructions) installed on computing device 200. In some examples, a version control agent (e.g., machine-executable instructions) for version control system 261 may also be installed on computing device 200.

A determination engine 226 may determine, based on location information 286, that a backup of data 240 (e.g., directory 240) by backup system 270 is to be limited based on content stored by version control system 260. In such examples, engine 226 may determine that the backup of directory 240 by backup system 270 is to be a version aware backup, as described above. In some examples, engine 226 may compare location information 286 with version aware backup information 281 for backup system 270. As described above in relation to FIG. 1, version aware backup information 281 may comprise a list of locations associated with respective version control system(s), where the locations are selected to be relied upon for version aware backup. As an example, an interface engine 222 of system 220 may receive user selections of locations (e.g., URLs, etc.) of version control system(s) that may be relied upon for version aware backup. In some examples, the selected location(s) may include a location of version 250, or include a higher-level (e.g., root level) location for all of version control storage 262.

Based on a result of the comparison of location information 286 and version aware backup information 281, engine 226 may determine that directory 240 associated with location information 286 is selected for version aware backup by backup system 270 (i.e., is to be limited as described above). For example, if the result of the comparison indicates that location information 286, or higher-level location information encompassing location information 286 (e.g., a higher-level directory or path), is represented among version aware backup information 281, engine 226 may determine that directory 240 associated with location information 286 is selected for version aware backup by backup system 270.

In response to such a determination, a difference engine 227 may acquire difference information 290. In some examples, engine 227 may acquire difference information 290 from version control system 260. For example, engine 227 may acquire difference information 290 from version control agent 264. Difference information 290 may represent differences (e.g., each difference) between the data 240 stored in memory 230 and the version 250 of data 240 stored in version control storage 262.

As noted above, in the example of FIG. 2, data 240 stored in memory 230 comprises a plurality of version controlled files 242 in a version controlled directory 240. In such examples, the version 250 of directory 240 stored in version control storage 262 comprises respective versions 252 of version controlled files 242. In some examples, difference information 290 may comprise a copy of each of version controlled files 242 that differs from its respective version in among versions 252 stored in version control storage 282. In other examples, difference information 290 may comprise a change file as described above in relation to FIG. 1. In each of such examples, difference information 290 may exclude at least a portion of the data 240 stored locally that is unchanged relative to the version 250 stored in version control storage 262.

In the example of FIG. 2, a storage engine 228 may store version information 284, location information 286, and difference information 290 in remote backup storage 272 of backup system 270. In some examples, engine 228 may store version access information 282 including the version and location information 284 and 286 in storage 272. In some examples, version controlled directory 240 may comprise file(s) 244 (e.g., “private” or “view private” files) not under version control by version control system 260. In such examples, storage engine 228 may also store the private file(s) 244 in remote backup storage 272.

In the example of FIG. 2, after the version aware backup of directory 240, system 220 may proceed to detect other data stored locally at computing device 200 for backup by backup system 270. For example, detect engine 221 may detect data 246 stored in memory 230 and under version control by version control system 261 separate from systems 260 and 270, and including version control storage 265 separate from storage 262 and storage 272. In such examples, a version 256 of data 246 may be stored in version control storage 265. In response to detecting data 246, engine 225 may acquire other location information specifying a location at which version 256 is accessible in version control storage 265 remote from computing device 200, and engine 226 may compare the other location information with version aware backup information 281.

Based on a result of the comparison, engine 226 may determine that non-version aware backup is to be performed by backup system 270 for data 246. For example, if the result of the comparison indicates that neither the other location information nor higher-level location information encompassing the other location information is represented among version aware backup information 281, engine 226 may determine that non-version aware backup is to be performed for data 246. In response to such a result, storage engine 228 may store data 246 in remote backup storage 272 in any suitable manner such that data 246 is restorable from backup system 270 independent of any version control system.

In some examples, detect engine 221 of system 220 may further proceed to defect non-version controlled data 247 that is not under version control by any version control system. In such examples, storage engine 228 may further store the non-version controlled data 247 in remote backup storage 272 such that the non-version controlled data 247 is restorable from backup system 270 independent of any version control system. In some examples, acquisition engine 225 may determine that data 247 is not under version control by determining that no version access information (e.g., version and location information) is associated with data 247. In such examples, acquisition engine 225 may determine that data 240 and 246 are each under version control by determining that version access information is associated with each of data 240 and 246.

In the example of FIG. 2, a restore engine 229 may restore data 240 (e.g., directory 240) to computing device 200 from at least version 250 stored in version control storage 262 and difference information 290 stored in the remote backup storage. In the example of FIG. 2, restored directory 245 represents directory 240 as restored by engine 229. Restored directory 245 may be restored to a storage medium of computing device 200.

As an example, restore engine 229 may access the version and location information 284 and 286 stored in remote backup storage 272 and acquire version 250 of directory 240 from version control storage 262 based on version and location information 284 and 286. For example, restore engine 229 may retrieve the version 250 identified by version information 284 from the location indicated by location information 286. In other examples, engine 229 may provide version control system 260 (e.g., version control agent 264) with a request for version 250, where the request specifies the version and location information 284 and 286. Restore engine 229 may further retrieve difference information 290 from remote backup storage 272 and incorporate (e.g., merge, etc.) each difference represented in difference information 290 into version 250 acquired by computing device 200 from version control system 260. Restore engine 229 may also retrieve private files 244 to further incorporate (e.g., merge) with version 250 and difference information 290. In this manner restore engine may produce restored directory 245.

In some examples, restore engine 229 may restore each of data 246 and 247 to computing device 200 from version control storage 272 independent of any version control system. In some examples, restore engine 229 may further restore, to computing device 200, other data subjected to version aware backup by another computing device. In such examples, engine 229 may restore the other data to computing device 200 based on a version of the other data stored in version control storage (e.g., storage 262) and other difference information associated with the version of the other data and stored in remote backup storage 272 by another computing device. In such examples, restore engine 229 may restore the other data as described above in relation to restoring directory 240. In some examples, functionalities described herein in relation to FIG. 2 may be provided in combination with functionalities described herein in relation to any of FIGS. 1 and 3-4.

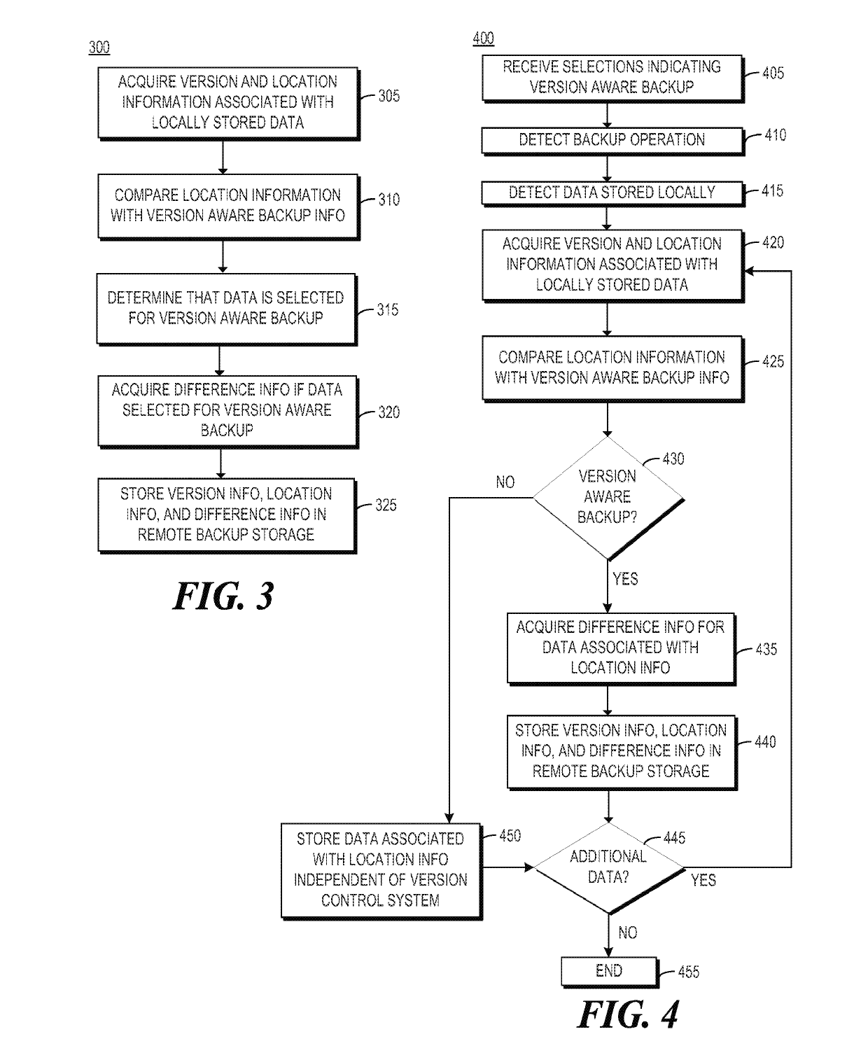

FIG. 3 is a flowchart of an example method 300 for storing difference information in a backup system. Although execution of method 300 by computing device 200 of FIG. 2 is described below, other suitable computing devices (e.g., computing device 100) can be utilized for the execution of method 300. Additionally, implementation of method 300 is not limited to such examples.

At 305 of method 300, engine 225 may acquire version and location information 284 and 286 each associated with data 240 (e.g., directory 240) stored locally at the computing device 200 (e.g., in memory 230). As described above, version information 284 may identify version 250 of data 240, where version 250 is stored remotely from computing device 200 in version control storage 262 of version control system 260 at a location identified by location information 286.

At 310, engine 226 may compare location information 286 with version aware backup information 281 for backup system 270, which is separate from version control system 260. At 315, engine 226 may determine that data 240 associated with location information 286 is selected for version aware backup by backup system 270, based on a result of the comparison of location information 286 and version aware backup information 281.

At 320, in response to the determination that data 240 is selected for version aware backup, difference engine 227 may acquire difference information 290 from version control system 260. Difference information 290 may represent differences (e.g., each difference) between data 240 stored locally (e.g., in memory 230) and the version 250 of data 240 stored in version control storage 262, and may exclude at least a portion of data 240 that is unchanged relative to version 250 stored in version control storage 262. At 325, engine 228 may store version information 284, location information 286, and difference information 290 in remote backup storage 272 of backup system 270.

Although the flowchart of FIG. 3 shows a specific order of performance of certain functionalities, method 300 is not limited to that order. For example, the functionalities shown in succession in the flowchart may be performed in a different order, may be executed concurrently or with partial concurrence, or a combination thereof. In some examples, functionalities described herein in relation to FIG. 3 may be provided in combination with functionalities described herein in relation to any of FIGS. 1-2 and 4.

FIG. 4 is a flowchart of an example method 400 for determining whether data associated with location information is selected for version aware backup by a backup system. Although execution of method 400 by computing device 200 of FIG. 2 is described below, other suitable computing devices (e.g., computing device 100) can be utilized for the execution of method 400. Additionally, implementation of method 400 is not limited to such examples.

At 405 of method 400, interface engine 222 of system 220 may receive a selection indicating that data associated with location information 286 (e.g., data 240) is selected for version aware backup by backup system 270. For example, the selection may be a selection of location information 286 (or higher-level location information encompassing location information 286), which may indicate that any data associated with that location information 286 is selected for version aware backup.

At 410, engine 221 may detect a trigger 283 to begin a backup operation of backup system 270 for computing device 200, as described above in relation to FIG. 2. At 415, in response to the backup operation of backup system 270 being triggered for the computing device, engine 221 may detect data 240 stored locally at computing device 200 (e.g., in memory 230) for backup by backup system 270. In response to the detection of data 240, engine 225 may, at 420, acquire version and location information 284 and 286, each associated with data 240 (e.g., directory 240). As described above, version information 284 may identify version 250 of data 240, where version 250 is stored remotely from computing device 200 in version control storage 262 of version control system 260 at a location identified by location information 286.

At 425, engine 226 may compare location information 286 with version aware backup information 281 for backup system 270, which is separate from version control system 260. At 430, engine 226 may determine whether data 240 associated with location information 286 is selected for version aware backup by backup system 270, based on a result of the comparison of location information 286 and version aware backup information 281.

If it is determined that data 240 is selected for version aware backup, method 400 may proceed to 435 at which difference engine 227 may acquire difference information 290 from version control system 260. Difference information 290 may represent differences (e.g., each difference) between data 240 stored locally (e.g., in memory 230) and the version 250 of data 240 stored in version control storage 262, and may exclude at least a portion of data 240 that is unchanged relative to version 250 stored in version control storage 262. At 440, engine 228 may store version information 284, location information 286, and difference information 290 in remote backup storage 272 of backup system 270.

At 445, detect engine 221 may determine whether there is additional data for backup by backup system 270. If not, then method 400 may proceed to 455, where method 400 may end. If so, then method 400 may return to 420 at which engine 225 may acquire other location information specifying a location at which a version 256 of other data 246 (stored locally at computing device 200) is accessible in other version control storage 265 of another version control system 261, where storage 265 is remote from computing device 200.

Method 400 may them proceed to 425 where engine 226 may compare the other location information with version aware backup information 281. At 430, engine 226 may determine whether the other data 246 associated with the other location information is selected for version aware backup by backup system 270, based on a result of the comparison of the other location information and version aware backup information 281. If not, then method 400 may proceed to 450. For example, method 400 may proceed to 450 in response to a result of the comparison of the other location information and version aware backup information 281 indicating that non-version aware backup is to be performed by backup system 270 for the other data 246. At 450, engine 228 may store the other data 246 in remote backup storage 272 such that other data 246 is restorable from backup system 270 independent of any version control system. Method 400 may then return to 445.

Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. In some examples, functionalities described herein in relation to FIG. 4 may be provided in combination with functionalities described herein in relation to any of FIGS. 1-3.

What is claimed is:

1. A non-transitory machine-readable storage medium comprising instructions to implement at least a portion of a backup system, the instructions executable by a processing resource of a computing device to:
acquire, from a version control system, version access information associated with data stored locally by the computing device, wherein the version access information is useable by the computing device to access a version of the data that is stored remotely from the computing device in version control storage of the version control system;
store, in remote backup storage of the backup system, the version access information and difference information representing differences between the data stored locally and the version of the data stored in the version control storage; and
restore the data to the computing device from at least the version of the data stored in the version control storage and the difference information stored in the remote backup storage.

2. The storage medium of claim 1, wherein the instructions to acquire the version access information comprise instructions to:
in response to a backup operation of the backup system being triggered for the computing device, detect the data stored locally; and
in response to the detection, acquire the version access information associated with the data from the version control system.

3. The storage medium of claim 2, wherein the version access information includes version information identifying the version of the data that is stored in the version control storage, and location information identifying a remote computer network location of the version control storage at which the version of the data is accessible to the computing device.

4. The storage medium of claim 3, wherein the instructions to store comprise instructions to:
compare the location information to a plurality of locations specified in version aware backup information;
determine, based on the result of the comparison, that a backup of the data by the backup system is to be limited based on content stored by the version control system; and
in response to the determination, acquire the difference information from the version control system.

5. The storage medium of claim 4, wherein:
the data stored locally comprises a plurality of version controlled files in a directory, and the version or the data stored in the version control storage comprises a respective version of each of the version controlled files; and
the difference information comprises a change file specifying, for each of the version controlled files, each difference between the version controlled file stored locally and the version of the version controlled file stored in the version control storage.

6. A computing device to implement at least a portion of a backup system, the computing device comprising:
memory to store data, wherein a version of the data is stored remotely from the computing device in version control storage of a version control system separate from the backup system;
an acquisition engine to, in response to a backup operation of the backup system being triggered, acquire version information identifying the version of the data and location information specifying a location at which the version is accessible by the computing device in the version control storage;
a storage engine to store, in remote backup storage of the backup system, the version information, the location information, and difference information representing differences between the data stored in the memory and the version of the data stored in the version control storage, wherein the version control storage and the backup storage are separate; and
a restore engine to restore the data to the computing device from at least the version of the data stored in the version control storage and the difference information stored in the remote backup storage.

7. The computing device of claim 6, further comprising:
an identification engine to identify the version control system utilized by the computing device; and
a determination engine to determine, based on the location information, that a backup of the data by the backup system is to be limited based on content stored by the version control system.

8. The computing device of claim 7, further comprising:
a difference engine to, in response to the determination, acquire the difference information from the version control system;
wherein the data stored in the memory comprises a plurality of version controlled files in a version controlled directory, and the version of the data stored in the version control storage comprises a respective version of each of the version controlled files; and
wherein the difference information comprises a copy of each of the version controlled files that differs from its respective version in the version control storage.

9. The computing device of claim 8, wherein:
the version controlled directory further comprises at least one private file not under version control by the version control system;
the storage engine is further to store the at least one private file in the remote backup storage; and
the difference information excludes at least a portion of the data stored locally that is unchanged relative to the version stored in the version control storage.

10. The computing device of claim 6, wherein the data stored in the memory comprises a plurality of version controlled files in a version controlled directory, the computing device further comprising:
an update engine to, in response to the backup operation of the backup system being triggered, determine whether the version controlled directory and the version controlled files are associated with the same version identifier of the version control system;
wherein, in response to a determination that any of the version controlled files and the version controlled directory are associated with different version identifiers of the version control system, the update engine is further to cause the version control system to update the version controlled files and the version controlled directory such that they are associated with the same version identifier of the version control system.

11. The computing device of claim 6, further comprising:
a detect engine to detect non-version controlled data stored in the memory;
wherein the storage engine is further to store the non-version controlled data in the remote backup storage such that the non-version controlled data is restorable from the backup system independent of any version control system.

12. The computing device of claim 11, wherein:
the restore engine is to access the version and location information stored in the remote backup storage and acquire the version of the data from the version control storage based on the version and location information; and
the restore engine is further to retrieve the difference information from the remote backup storage and incorporate each difference represented in the difference information into the version of the data acquired by the computing device from the version control system.

13. A method comprising:
acquiring, with a computing device, version information and location information each associated with data stored locally at the computing device, the version information identifying a version of the data that is stored remotely from the computing device in version control storage of a version control system at a location identified by the location information;
comparing the location information with version aware backup information for a backup system separate from the version control system;
based on a result of the comparison of the location information and the version aware backup information, determining that the data associated with the location information is selected for version aware backup by the backup system;
in response to the determination, acquiring, from the version control system, difference information representing differences between the data stored locally and the version of the data stored in the version control storage and excluding at least a portion of the data stored locally that is unchanged relative to the version stored in the version control storage; and
storing, with the computing device, the version information, the location information, and the difference information in remote backup storage of the backup system.

14. The method of claim 13, further comprising:
receiving a selection indicating that the data associated with the location information is selected for version aware backup by the backup system; and
in response to a backup operation of the backup system being triggered for the computing device, detecting the data stored locally at the computing device, wherein the version and location information associated with the data is acquired in response to the detection.

15. The method of claim 14, further comprising:
acquiring other location information specifying a location at which a version of other data, stored locally at the computing device, is accessible in other version control storage remote from the computing device;
comparing the other location information with the version aware backup information; and
in response to a result of the comparison of the other location information and the version aware backup information indicating that non-version aware backup is to be performed by the backup system for the other data, storing the other data in the remote backup storage such that the other data is restorable from the backup system independent of any version control system.
